(19) United States
(12) Patent Application Publication
(10) Pub. No.: US 2023/0075571 A1
(43) Pub. Date: Mar. 9, 2023

(54) DEVICE FOR THE DETECTION OF GAMMA RAYS BASED ON METASCINTILLATOR BLOCK DETECTORS

(71) Applicants: UNIVERSITAT POLITECNICA DE VALENCIA, Valencia (ES); CONSEJO SUPERIOR DE INVESTIGACIONES CIENTÍFICAS (CSIC), Madrid (ES); MULTIWAVE METACRYSTAL SA, Geneva (CH)

(72) Inventors: Paul LECOQ, Chevry (FR); Jose Maria BENLLOCH BAVIERA, Madrid (ES)

(21) Appl. No.: 17/797,011

(22) PCT Filed: Feb. 2, 2021
(86) PCT No.: PCT/EP2021/052429

§ 371 Date: Aug. 2, 2022

(30) Foreign Application Priority Data
Feb. 3, 2020 (ES) P202030081

(51) Int. Cl. G01T 1/164; G01T 1/20; G01T 1/29

(52) U.S. Cl. CPC G01T 1/1644; G01T 1/2006; G01T 1/2985

(57) ABSTRACT

A device for the detection of gamma rays used primarily in a PET scanner is based on a scintillator heterostructure combining the high stopping power of scintillators commonly used in PET scanners (such as L(Y)SO, BGO, etc.) and very fast scintillators based on polymers loaded with fast emitting dyes or nanocrystals, or thin layers of nanocrystals or multiple quantum well structures. The particular arrangement of this detector module allows combining all the important features of a high-performance Time-of-Flight PET (TOFPET) detector module, i.e., a high photoelectric detection efficiency for the gamma rays, a precise 3D information (including the depth of interaction DOI) of the gamma ray conversion in the module, and good energy resolution.

### FIELD OF THE INVENTION

The invention relates to a device for the detection of gamma rays. The device of the invention can be applied, preferably but without limitation, to positron-emission tomography (PET) scanner technologies.

### BACKGROUND OF THE INVENTION

Current techniques for in-vivo molecular imaging, such as time-resolved quantitative multiparametric imaging, pharmacodynamic studies or in-vivo tracking of a small number of cells for stem-cell tissue repair therapy, cancer immunotherapy, etc., can highly benefit from achieving improved molecular sensitivities and processing speeds. In this context, high-precision Time-of-Flight PET (TOF PET) scanners are very promising technologies able to provide a substantial increase in the signal-to-noise ratio of the reconstructed images, as well as allowing the possibility to achieve very high sensitivities in PET scanners at the sub-picomolar level (see P. Lecoq, “Pushing the limits in Time-Of-Flight PET imaging”, IEEE T. Radiat. Plasma Med. Sci., Vol. 1, No. 6 (2017) 473-485).

When studying gamma-ray interactions, the localisation of the emission point of an annihilation pair along a line-of-response (LOR), defined by the nearly coincident detection of a pair of annihilation gamma rays, depends on the detection time difference between the two annihilation photons (also known as the time-of-flight (TOF) difference of the photons), whose accuracy is given by the coincidence time resolution (CTR) of a detection chain. It is well known that this information allows reducing the noise variance associated to the “3D-PET ill-posed tomographic inversion problem” by a factor proportional to the CTR reduction:

$${( \frac{S N {R}_{T O F}}{S N {R}_{n o n T O F}} )}^{2} = \frac{2 D}{c \times C T R} ,$$

where D is the diameter of the field-of-view (FOV) and c is the speed of light in vacuum (see M. Conti, “Focus on Time-of-Flight PET: the benefits of improved time resolution”, Eur J. of Nuc. Med. Mol. Imaging, (2011) 38, 1147-1157). This variance gain is associated to a similar gain (G) in the effective sensitivity of the PET scanner (see M. Conti, B. Bendriem “The new opportunities for high time resolution clinical TOF PET”, Clinical and Translational Imaging (2019) 7:139-147), given by the formula:

$${G}_{s e n s} = {( \frac{S N {R}_{T O F}}{S N {R}_{n o n T O F}} )}^{2} / 1.47 .$$

A CTR resolution of 100 ps would improve the effective sensitivity of the PET scanner by a factor of about 2, as compared to the best TOFPET scanner today (currently, Biograph

Vision™ from Siemens, see for example: https://usa.healthcare.siemens.com/molecular-imaging/pet-ct/biograph-vision), and by a factor of 18, as compared to a PET scanner with no TOF capability. Would the CTR reach 10 ps, the sensitivity gain would be 180, as compared to a non-TOFPET, and more than 20, as compared to Biograph Vision™, respectively.

Achieving a CTR of about 10 ps FWHM (“full width at half maximum”) would allow to obtain a direct three-dimensional (3D) volume representation of the estimated activity distribution of a positron-emitting radiopharmaceutical, at the mm level and without the need for tomographic inversion. This would constitute a remarkable improvement in PET imaging and quantification. Moreover, a two-order of magnitude gain in the effective sensitivity would have the following consequences for PET scanners:
reduction of the radiation doses of molecular imaging procedures to negligibly low levels;
reduction of the synthesised quantity of radiopharmaceutical needed for each examination and, thus, of the relatively high cost currently associated with in-vivo molecular imaging procedures;
further extension of the benefit of molecular-imaging procedures beyond oncology towards cardiovascular, neurological, metabolic, inflammatory, infectious, or metabolic disease (such as diabetes) medicine, including in the pediatric, neonatal, and prenatal medicine;
maximising the spatial and temporal resolution of PET-based molecular imaging;
precise dynamic studies of molecular processes of high interest in pharmacology, for screening and selecting candidate molecules for the next generation of drugs or new applications thereof;
potentially further extension of molecular in-vivo imaging to study “systems biology” of the whole human body, through whole-body imaging systems;
avoidance of the need of full-angular coverage of the patient for imaging procedures, opening many new opportunities for PET system designs.

In order to improve the time resolution of TOFPET scanners, the concept of “metascintillators” has been recently proposed by one of the inventors of this patent application (see R. M. Turtos, Paul Lecoq et al., “On the use of CdSe scintillating nanoplatelets as time taggers for high-energy gamma detection”, npj 2D Mater Appl 3, 37 (2019) doi:10.1038/s41699-019-0120-8). As a novel proposal over the known prior art, the present invention discloses a device for detecting gamma rays which is based on a combination of metascintillators and “block detectors” that improve the sensitivity of a PET scanner, by reducing the dead space between crystals in a pixellated approach. This proposal allows achieving a CTR resolution of at least 100 ps, and even to at least 10 ps in the near future, in combination to the expected optimisation of photodetectors and their electronics in the next years.

### SUMMARY OF THE INVENTION

In the light of the problems of the state of the art set forth in the previous section, the present invention proposes a high-resolution gamma ray detection device which preferably comprises at least two metascintillator block detectors, wherein each of said metascintillator block detectors comprises a stack of alternate heavy scintillator layers and ultrafast scintillator layers, synergistically combining the concept of “metascintillators” and “block detectors” as proposed individually in the prior art. More preferably, each metascintillator block detector comprises a prismatic body, wherein at least two of the sides of said body are partially or totally covered by an array of photodetectors. In a preferred

In the context of the invention, a heavy scintillator layer is any layer material, or combination of materials, having a density substantially equal to or above 5 g/cm³ (more preferably, between 5 and 10 g/cm³), an effective atomic number substantially equal to or above 50, a light yield substantially equal to or above 10,000 photons/MeV (more preferably, comprised between 10,000 and 100,000 photons/MeV) and a scintillation decay time substantially equal to or above 10 ns (and, more preferably between 10 to 1,000 ns).

In a preferred embodiment of the invention, the heavy scintillator layers comprise BGO, LSO, LYSO, GSO, Nal, Csl, BaF2, LuAP, LuAG and/or GGAG scintillation materials, alone or in combination.

In a further preferred embodiment of the invention, one or more of the heavy scintillator layers have a density between 6 and 8 g/cm³, an effective atomic number higher than 60, a light yield above comprised between 10,000 and 60,000 photons/MeV and/or a scintillation decay time between 10 to 100 ns.

In a further preferred embodiment of the invention, the thickness of the heavy scintillator layers is comprised between 100 and 500 microns.

In a further preferred embodiment of the invention, the total number of heavy scintillator layers in the metascintillator block detector is between 50 to 150.

In the context of the invention, an ultrafast scintillator layer is any layer material, or combination of materials, having a scintillation production rate of at least 100 photons per 100 keV of energy deposited in less than 1 ns.

In a preferred embodiment of the invention, the ultrafast scintillator layers have:
a scintillation production rate of between 100 and 5,000 photons per 100 keV of energy deposited in less than 1 ns; and/or
a scintillation production energy of up to 20% of the incident energy of the gamma rays to be detected.

In a further preferred embodiment of the invention, the ultrafast scintillator layers have a thickness between 20 to 200 microns.

In a further preferred embodiment of the invention, the fast-scintillating layers comprise dye-loaded plastic scintillators, polymers loaded with nanocrystals, layers of nanocrystals or quantum-well structures.

In a further preferred embodiment of the invention, the metascintillator block detector is cubic or has the form of a rectangular prism, and two or four of its opposite faces are partially or totally covered by an array of photodetectors.

In a further preferred embodiment of the invention, the photodetectors have a single photon time response (SPTR) characteristic between 10 to 100 ps.

In a further preferred embodiment of the invention, each individual photodetector has a surface between 1×1 mm² and 6×6 mm².

In a further preferred embodiment of the invention, the arrays of photodetectors comprise a juxtaposition of individual photodetectors, lines of packaged photodetectors or photodetector matrices.

In a further preferred embodiment of the invention, two of the opposite faces of the metascintillator block detector are partially or totally covered by an array of photodetectors and two other opposite faces are covered by optical reflector element so as to allow channeling of the light in the heavy scintillator layers and ultrafast scintillating material layers, in the direction of the photodetectors.

In a further preferred embodiment of the invention, the planes of the heavy scintillator layers and the ultrafast scintillating material layers are arranged substantially orthogonal to a main incidence direction of a gamma ray source.

In a further preferred embodiment of the invention, the device comprises a plurality of cuboid or tapered metascintillator block detectors assembled in a ring geometry.

In the context of the invention, the expression “substantially” will be understood as equal to, or within a ±15% range of variation.

### DESCRIPTION OF THE DRAWINGS

The foregoing and other features and advantages will be more fully understood from the detailed description of the invention, as well as from the preferred embodiments referring to the attached figures, which are described in the following paragraphs, wherein:

FIGS. 1a-1b depict two examples (cuboid and tapered, respectively) of a metascintillator block detector, configured as a stack of alternate layers of dense and ultrafast scintillators, according to a preferred embodiment the present invention.

FIG. 2 schematically represents the energy deposit in the two materials of a scintillator heterostructure.

FIG. 3 shows a metascintillator block detector covered by arrays of photodetectors on its four lateral faces, according to a preferred embodiment the present invention.

FIG. 4 illustrates the principle of position determination in x, y, and z directions, in a metascintillator block detector covered by four lateral faces of photodetector arrays, according to a preferred embodiment the present invention.

FIG. 5 illustrates the principle of position determination in x, y, and z directions, in a metascintillator block detector covered by two lateral faces of photodetector arrays, according to a preferred embodiment the present invention.

### Numerical References Used in the Drawings

| | |
|---|---|
| (1) | Gamma-ray metascintillator block detector |
| (2) | Heavy scintillator layers |
| (3) | Ultrafast scintillator layers |
| (4) | Photodetectors |
| (5) | Optical reflector element |

### DETAILED DESCRIPTION OF THE INVENTION

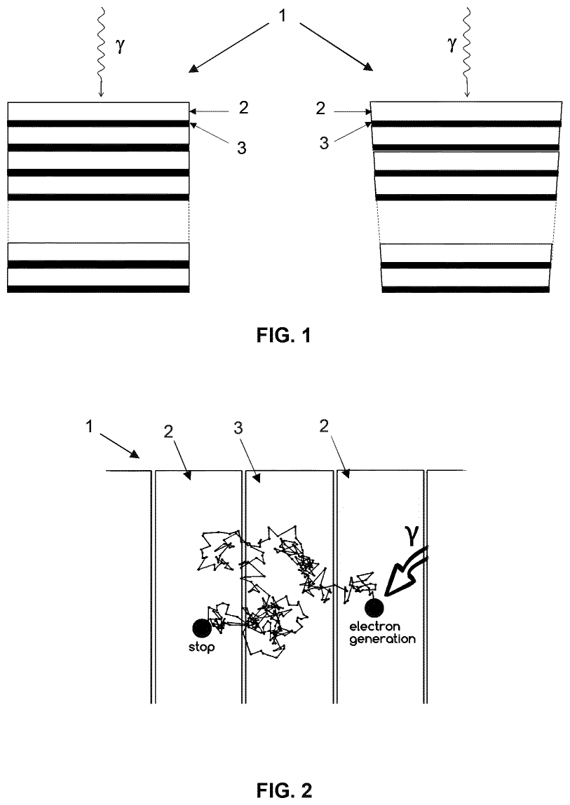

A detailed description of the invention related to different preferred embodiments thereof, based on FIGS. 1-5 of this document, is set forth below. Said description is provided for illustrative, but not limiting, purposes of the claimed invention.

In a preferred embodiment of the present invention (FIGS. 1a-1b), a gamma-ray metascintillator block detector (1) is assembled as a stacked of alternate heavy scintillator layers (2) and ultrafast scintillator layers (3) (as described in the summary of the invention), whose planes are preferably arranged substantially orthogonal to the main incidence direction of the gamma rays. The arrangement of alternate heavy scintillator layers (2) and ultrafast scintillating material layers (3) in a metascintillator block detector (1) of the device according to the invention will be also designated as “heterostructure”.

In different embodiments of the invention, the shape of the gamma ray metascintillator block detector (1) can be cuboid (FIG. 1a) or tapered (FIG. 1b), so as to allow the assembly of several metascintillator block detectors (1) in a ring geometry. In a further preferred embodiment of the invention, the metascintillator block detectors (1) can be arranged in one or more pairs, opposite to each other.

The heavy scintillator layers (2) can be made of scintillators commonly used in gamma detectors, such as BGO, LSO, LYSO, GSO, Nal, Csl, BaF₂, LuAP, LuAG, GGAG, etc. However, any material or combination of materials having density, atomic number, light yield and/or emission times so to allow a good gamma ray detection efficiency/cm, good energy resolution and/or spatial determination of the gamma interaction point within the material, and data acquisition rates compatible with common gamma-ray detection applications (up to a few MHz), can be also used as the material of the heavy scintillator layers (2), for the purposes of the invention. For instance, in the case of a PET scanner, the majority of the listed crystals have a density between 6 and 8 g/cm3, an effective atomic number (EAN) higher than 60, a light yield comprised between 10,000 and 60,000 photons/MeV and a scintillation decay time in the range of tens to hundreds of ns.

The thickness of the heavy scintillator layers (2) is determined by the range of the recoil electron from a photoelectric gamma ray conversion event, which is typically of the order of 100 to 300 microns in the preferred materials, for 511 keV gamma energy.

The total number of such heavy scintillator layers (2) in the device of the invention is determined by the desired gamma-ray detection efficiency for the metascintillator block detector (1). For instance, common PET scanners use heavy crystal lengths ranging from 10 mm to 30 mm, which corresponds to 50 to 150 layers (2) of 200 microns thick.

On the other hand, the ultrafast scintillator layers (3) of the metascintillator block detector (1) are designed to probe the photoelectric recoil electrons in such a way so as to typically produce a bunch of several hundreds to a few thousands prompt photons, for an initial energy deposit of about 100 keV. The reason for limiting the energy deposit in this material, preferably up to 20% of the initial gamma energy, is to limit the impact of the sampling fluctuations on the energy resolution of the stack for the case the intrinsic light yield of the two materials would be different. An indicative thickness for these fast-scintillating layers can range between 20 microns to 200 microns, depending on the intrinsic light yield of the material chosen.

In different embodiments of the invention, the ultrafast-scintillating layers (3) can be made of plastic scintillators (dye-loaded), polymer loaded with nanocrystals, thin layers of nanocrystals or multiple quantum-well structures, or any other material with a fast scintillation allowing the production of at least several hundreds of photons per 100 keV of energy deposited in less than 1 ns.

In order to allow for an energy sharing of the recoil electron in both materials of the heterostructure of heavy scintillator layers (2) and ultrafast scintillator layers (3) formed in the metascintillator block detector (1) of the invention, the thickness of the heavy scintillator layers (2) is, preferably, of the order of 200 microns, its exact value depending on the characteristics of the chosen heavy scintillator material FIG. 2 depicts a schematic representation of the energy deposit in the layers (2, 3) forming the heterostructure.

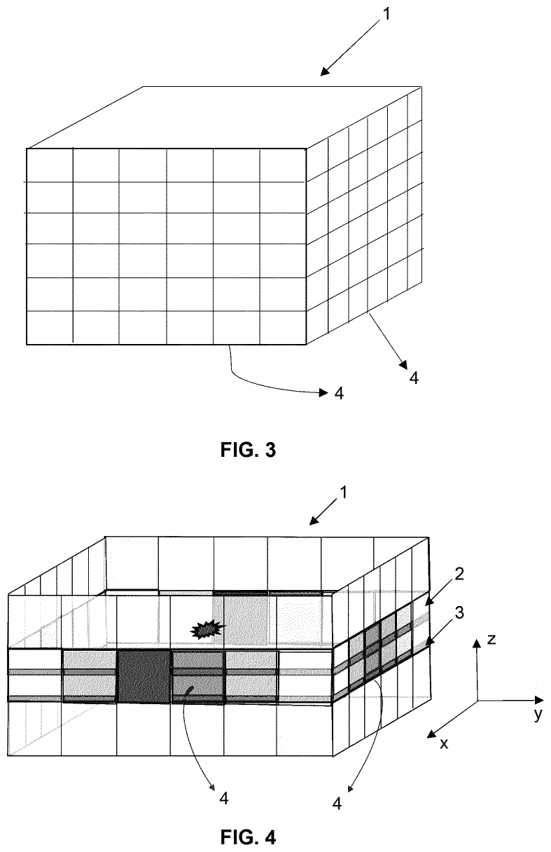

In a further embodiment of the invention, the metascintillator block detector (1) is cubic or has the form of a rectangular prism and four of its faces are preferably covered by an array of photodetectors (4) (see FIG. 3). These photodetectors (4) comprise preferably silicon photomultipliers (SiPM) but can be of any type, provided that they have a time response characteristic compatible with the 10 to 100 ps coincidence time resolution (CTR) objective. The area of each individual photodetector (4) will typically range from 1×1 mm² to 6×6 mm², depending on the timing and spatial resolution performance objectives of the metascintillator block detector (1). These arrays of photodetectors (4) can be made of the juxtaposition of individual photodetectors (4), or of lines of packaged photodetectors (4) or photodetector (4) matrices.

As depicted in FIG. 4, the position of the gamma-ray interaction will be determined in depth (z direction) by the identification of the scintillator layer (or group of layers) emitting light with a precision defined by the photodetector (4) array's granularity in z, x, and y, by the light sharing and time distribution of the signals received by the photodetectors (4) facing the light emitting layers (2, 3) on opposite sides of the metascintillator block detector (1). It can be calculated that the total surface of photodetectors (4) needed in this configuration is similar to the one of the commercial PET readout on the back of the crystals, if the metascintillator block detector (1) has lateral dimensions equal to 4 times their thickness.

Moreover, considering that scintillating crystals in commercial PET are usually arranged in a pixel distribution of about 3×3 mm² section, spaced by at least 100 microns, and that SiPM photodetectors can be made as thin as 1 mm, the total dead space in both configurations is equivalent if the metascintillator block detector (1) has a section of at least 6×6 cm².

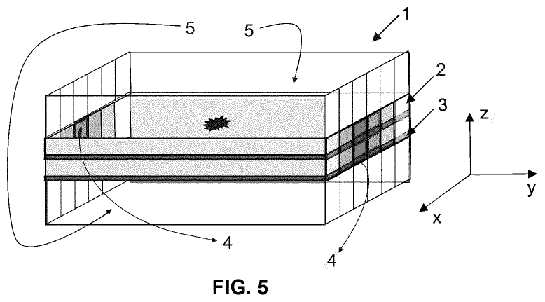

In a third embodiment of the invention, the readout of the device can be provided over two opposite faces of the metascintillator block detector (1) instead of four (for a cuboid or prism block (1)), thereby reducing the total number and cost of the photodetectors (4) by a factor 2 and allowing the assembly of PET rings with basically no dead space (as seen in FIG. 5). In this case, the two lateral faces of the metascintillator block detector (1) which are not readout by photodetectors (4) will be preferable covered by an optical reflector element (5) so as to allow easy channeling of the light in the scintillating layers (2, 3), in the direction of the photodetectors (4).

In a fourth embodiment of the invention, each of the scintillating layers (dense (2) and/or fast (3)) can be segmented to restrict the number of photodetectors (4) collecting the light at both ends of the metascintillator block detector (1). This possibility provides flexibility for the optimisation of the spatial and time resolution of the heterostructure, as a function of the scintillator layers (2, 3) and photodetector (4) material and geometric characteristics. This embodiment can also have a positive impact on the production cost of the layers (2, 3).

1. A device for the detection of gamma rays comprising at least two metascintillator block detectors, wherein each metascintillator block detector comprises a stack of alternate heavy scintillator layers and ultrafast scintillator layers, wherein:
each heavy scintillator layer has a density substantially equal to or above 5 g/cm³, an effective atomic number substantially equal to or above 50, a light yield substantially equal to or above 10,000 photons/MeV and a scintillation decay time substantially equal to or above 10 ns;
each ultrafast scintillator layer of the metascintillator block detector having a scintillation production rate of at least 100 photons per 100 keV of energy deposited in less than 1 ns;
and wherein each metascintillator block detector comprises a prismatic body, wherein at least two of the sides of said body are partially or totally covered by an array of photodetectors.

2. The device according to claim 1, wherein the heavy scintillator layers comprise BGO, LSO, LYSO, GSO, NaI, CsI, BaF2, LuAP, LuAG and/or GGAG scintillation materials, alone or in combination.

3. The device according to claim 1, wherein one or more of the heavy scintillator layers have a density between 6 and 8 g/cm3, an effective atomic number higher than 60, a light yield comprised between 10,000 and 60,000 photons/MeV and/or a scintillation decay time between 10 to 100 ns.

4. The device according to claim 1, wherein the thickness of the heavy scintillator layers is comprised between 100 and 500 microns.

5. The device according to claim 1, wherein the total number of heavy scintillator layers in the metascintillator block detector, is between 50 to 150.

6. The device according to claim 1, wherein the ultrafast scintillator layers have:
a scintillation production rate of between 100 and 5,000 photons per 100 keV of energy
a scintillation production energy of up to 20% of the incident energy of the gamma rays to be detected.

7. The device according to claim 1, wherein the ultrafast scintillator layers have a thickness between 20 microns to 200 microns.

8. The device according to claim 1, wherein the ultrafast scintillator layers comprise dye-loaded plastic scintillators, polymers loaded with nanocrystals, layers of nanocrystals or quantum-well structures.

9. The device according to claim 1, wherein the metascintillator block detector is cubic or has the form of a rectangular prism, and two or four opposite faces of the device are partially or totally covered by an array of photodetectors.

10. The device according to the preceding claim 9, wherein the photodetectors have a time-response characteristic between 10 to 100 ps coincidence time resolution.

11. The device according to claim 9, wherein each individual photodetector has a surface between 1×1 mm² and 6×6 mm².

12. The device according to claim 9, wherein the arrays of photodetectors comprise a juxtaposition of individual photodetectors , lines of packaged photodetectors or photodetector matrices.

13. The device according to claim 9, wherein two of opposite faces of the device are partially or totally covered by an array of photodetectors, and two other opposite faces are covered by optical reflector element thereby allowing channelling of the light in the heavy scintillator layers and ultrafast scintillator layers, in the direction of the photodetectors.

14. The device according to claim 1, wherein the planes of the heavy scintillator layers and the ultrafast scintillator layers are arranged substantially orthogonal to a main incidence direction of a gamma ray source.

15. The device according to claim 1 any of the preceding claim 1, comprising a plurality of cuboid or tapered metascintillator block detectors assembled in a ring geometry.
